(19) United States
(12) Patent Application Publication
(10) Pub. No.: US 2006/0018488 A1
(43) Pub. Date: Jan. 26, 2006

(54) Bone conduction systems and methods

(76) Inventors: Roar Viala, Capestang (FR); John Mix, Beaver Court, CA (US)

Correspondence Address: James A. Gavney Jr., 725 Wildwood Lane, Palo Alto, CA, 94303, US

(21) Appl. No.: 11/212,510

(22) Filed: Aug. 24, 2005

Related U.S. Application Data
(63) Continuation-in-part of application No. 10/803,309, filed on Mar. 18, 2004.
(60) Provisional application No. 60/493,667, filed on Aug. 7, 2003.

(51) Int. Cl. H04R 1/10; H04R 25/00

(52) U.S. Cl. 381/74; 381/151

(57) ABSTRACT

A system for and method of communicating content data through bone conduction is disclosed. The content data can include radio content data, such as FM and AM radio content data, radio packet content data, recorded or stored content data and/or timing signals. The system includes bone conduction speakers configured to deliver the content data to a user through bone conduction using flexible contact diaphragms.

### RELATED APPLICATIONS

This application is a Continuation-in-Part of U.S. patent application Ser. No. 10/803,309, titled “UNDERWATER ENTERTAINMENT SYSTEM,” filed Mar. 18, 2004. The U.S. patent application Ser. No. 10/803,309, titled “UNDERWATER ENTERTAINMENT SYSTEM,” filed Mar. 18, 2004, claims priority under 35 U.S.C. § 119(e) from the co-pending U.S. provisional patent application Ser. No. 60/493,667, filed on Sep. 7, 2003, and titled “UNDERWATER DIGITAL MUSIC PLAYER.” The U.S. patent application Ser. No. 10/803,309, titled “UNDERWATER ENTERTAINMENT SYSTEM,” filed Mar. 18, 2004 and provisional patent application Ser. No. 60/493,667, filed on Sep. 7, 2003, and titled “UNDERWATER DIGITAL MUSIC PLAYER” are both hereby incorporated by reference.

### FIELD OF THE INVENTION

This invention relates to systems for and methods of transmitting content data using bone conduction. More particularly, this invention relates to systems for and methods of transmitting audible music signals, two-way communication signals and timing signals using bone conduction.

### BACKGROUND

Content data, such as music and voice communications, are often transmitted using audio signals that are made audible with a speaker or a headset having built-in speakers. There are a number of situations where it would be useful to transmit and/or receive content data where traditional speakers are either not useful or are unsafe. For example, when a person is in an aquatic environment, speakers do not perform well or can not be used at all. Also, when a person is performing an activity, such as running, skateboarding, snow skiing, water skiing, riding a bicycle or a motorcycle, it is not safe to listen to contend date using a headset with speakers, because the headset can prevent the user from hearing other sounds in the environment.

What is needed is a system for transmitting content data by means which can be used in aquatic environments and/or which can allow a user to hear other sounds in the environment while receiving the content data.

### SUMMARY OF THE INVENTION

The present invention is directed to a system for and a method of communicating content data to a user through bone conduction. The content data can include radio content data, such as FM and AM radio content data, or radio packet content data and two-way radio content data, such as is typically used for portable communication devices including, but not limited to, cellular phones, walkie talkies and the like. Bone conduction and bone conduction output data herein generally refer to the vibrations that are generated by a suitable device that has a surface in contact with a bony portion of a user, most notably, a bony portion of the user's head. The vibrations are transmitted through the bones and generate sound or an audible signal from within one or more internal cavities of the user's head, such as an inner ear canal.

In accordance with the embodiment of the of the invention, a system comprises headgear for coupling to a user's head. The headgear can be a headband, a visor, a hat, a helmet, a pair of goggles, a pair of glasses or combinations thereof. The system includes a control unit with a receiver configured to receive wireless content data, such as described above. The system also includes a converter coupled to the headgear for converting received wireless content data into bone conduction output data. The system also preferably includes a transmitter coupled to the headgear for transmitting wireless communication signals from sound. For example, the transmitter includes a radio transmitter coupled to a microphone, such that a user can speak into the microphone to generate or send outgoing communication signals to a second user wearing a similar system or other compatible device.

In accordance with further embodiments of the invention, the system includes a player unit for playing recorded or stored content data through the converting means, such as the bone conduction speaker. The player unit is preferably configured for playing digitally recorded or digitally stored content data in any suitable format, such as MP3 format (MPEG-1 Audio Layer-3 compressed format). The player unit can also be configured to record content data from a live content data stream. Further, the player unit can be configured to couple to an Internet-enabling device to download content data therefrom using, for example, a USB (Universal Serial Bus) connection or a wireless connection. Also, the player unit be internet enabled, such that the player unit can download content data directly over the internet. The player unit can also be network enabled, such that the player unit can interface with other electronic devices. For example, the player unit can employ “Blue Tooth” technology or any other suitable network technology.

In accordance with the preferred embodiment of the invention, a system includes bone conduction speakers with diaphragms that are placed in intimate contact with a bony portions of a user's head to generate audible sounds within one or more cavities of the users' head, such as described above. The diaphragms can be sealed diaphragms, such that the bone conduction speakers are suitable for use in aquatic environments. Preferably the diaphragms are capable of contouring to surfaces of the bony portions of the user's head, such that a large surface area of the diaphragms are in contact with the bony portions of the user's head. Further, the bone conduction speakers can include pressure compensators, such that the pressure differential across moving parts of the bone conduction speakers remains sufficiently equal to allow the speakers to operate at a range of different pressures.

In accordance with the embodiments of the invention, a system comprises a timer unit for generating timing signals at a selectable frequency. The timing signals are then converted to timing outputs transmitted to a user through one or more bone conduction speakers, such as described above.

In accordance with yet further embodiments of the invention a system is configured for two-way communication. The system comprises a transceiver for receiving incoming wireless communication signals and transmitting outgoing wireless communication signals. Preferably, the transceiver receives and transmits radio packet content data used in cellular phones. The system also includes one or more bone conduction speakers for converting the incoming wireless communication signals into bone conduction signals, such as described above. The system also includes an input device, preferably a microphone, for converting sound into the outgoing communication signals. The bone conduction speakers and microphone can be integrated with or configured to couple to any suitable headgear such as a headband, a visor, a hat, a helmet, a pair of goggles or a pair of glasses. The system can also includes a digital player unit for playing and recording digital music, such as described above.

### BRIEF DESCRIPTION OF FIGURES

FIG. 1 shows a system for transmitting content date using bone conduction, in accordance with the embodiments of the invention.

FIG. 2A shows a system configured to secure to a user's head and for transmitting content data using bone conduction, in accordance with the embodiments of the invention.

FIG. 2B shows a helmet with a built-in bone conduction system, in accordance with the embodiments of the invention.

FIG. 2C shows a pair of glasses with a built-in bone conduction system, in accordance with the embodiments of the invention.

FIG. 3A shows a touch control architecture for inputting system functions into a system using bone conduction, in accordance with the embodiments of the invention.

FIG. 3B shows an entertainment system configured to couple to a strap for securing the bone conduction system to a portion of a user's body, in accordance with the embodiments of the invention.

FIGS. 4A-B show exploded views of a bone conduction system, in accordance with the embodiments of the invention.

FIG. 5 shows a speaker-earplug for transmitting audio output signals from an entertainment system to a user's ear, while the user is in a water environment or submersed in water, in accordance with the embodiments of the invention.

FIG. 6A shows a sealed membrane bone conduction speaker unit for transmitting bone conduction output signals through a bony portion of a user's head, in accordance with the embodiments of the invention.

FIG. 6B shows a sealed membrane bone conduction speaker unit with a pressure compensator, in accordance with the embodiments of the invention.

FIG. 7 shows a headband with a built-in bone conduction system for transmitting content data to a user using bone conduction, in accordance with the embodiments of the invention.

FIGS. 8A-B show a bone conduction system with a timer circuit, in accordance with the embodiments of the invention.

### DETAILED DESCRIPTION OF THE INVENTION

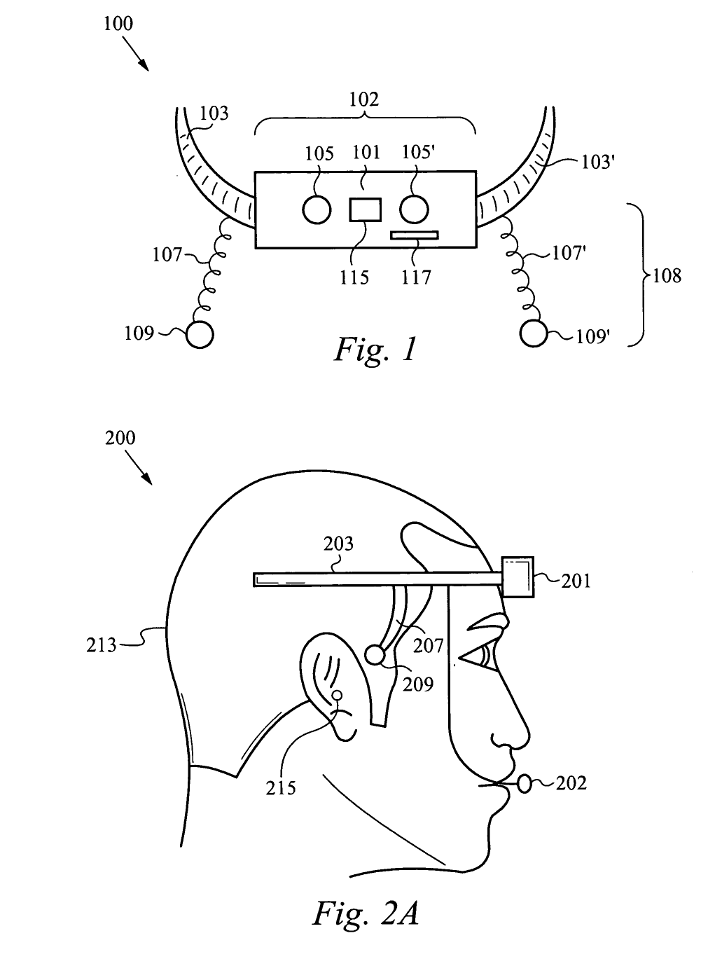

Referring to FIG. 1, the present invention is directed to a system 100 comprising a control unit 102 that can include a water resistant housing 101. Preferably, control unit 102 includes media player unit 115 and any necessary circuitry for receiving, transmitting, storing and playing content data. For example, necessary circuitry can include a digital processor unit, a digital signal processor (DSP), a digital-to-analog converter, data storage circuitry, software, a data storage unit, an amplifier, a power source, a transmitter, a receiver, etc. The control unit 102 can also include a USB connection or a wireless connection, slots for reading removable data storage devices or any other means known in the art for inputting content data. Also, the control unit 102 be Internet-enabled, such that the player unit 115 can download content data directly over the Internet. The control unit 102 can also be network enabled, such that control unit 102 can interface with other electronic devices.

In accordance with yet further embodiments of the invention, the control unit 102 includes a receiver unit 105 for receiving wireless content data or communication signals in real time. The system 100 can also include a transmitting unit 105′ for transmitting wireless content data or communication signals from the control unit 102 to a compatible receiving device. Preferably, the control unit 102 also includes an external or an internal antenna 117 for receiving wireless content data or communication signals. Wireless content data or communication signals can be generated or input using any suitable input means, including but not limited to input keys, a graphical user interface and/or a microphone, such as described below.

Still referring to FIG. 1, the system 100 includes an output or converting means 108 configured for delivering the content data received from the control unit 102 or being played from the media player unit 115 into a user friendly form. Preferably the output or converting means 108 includes pair of bone conduction speakers 109 and 109′ that can be permanently fixed to, or detachably coupled to, the control unit 102 through electrical connections 107 and 107′, respectively. The bone conduction speakers 109 and 109′ preferably include contact diaphragms that are placed against bony portions of a user's head to deliver the content data to the user via vibrations through bones in the users' head. The system 100 can include any suitable attaching means 103 and 103′ for attaching the system 100 to a portion or of the user's body, an article and/or vehicle.

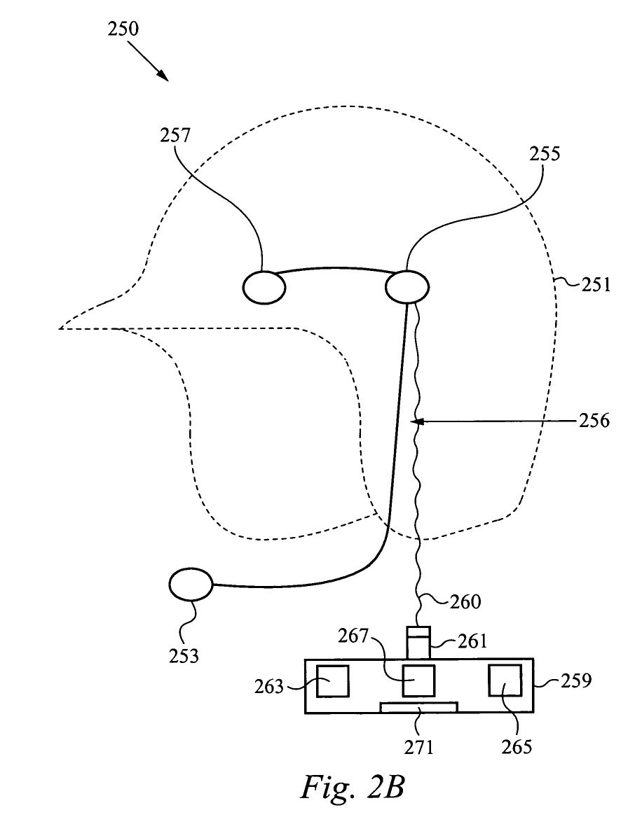

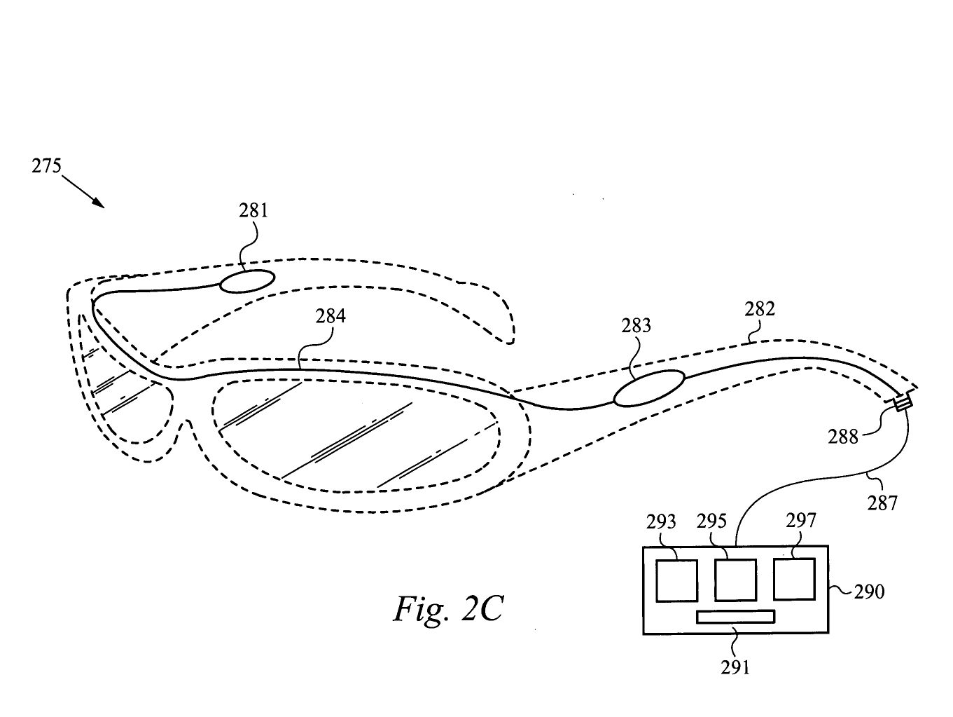

Referring now to FIG. 2A, a system 200 includes a control unit 201, such as described above with reference to FIG. 1. The control unit 201 preferably includes a radio transceiver for receiving and transmitting radio communication signals, in any suitable format including radio packet data. The system 200, also includes a headband 203 with one or more support structures 207 for supporting one or more corresponding bone conduction speakers 209. The headband 203 is preferably configured to hold the one or more bone conduction speakers 209 against a bony portion of a user's head 213. The head band 203 can also be configured to hold or support the control unit 201. The control unit 201 and/or the bone conduction speakers 209 can be configured to detachably couple to the headband 203 through any suitable attachment means including clips, snaps, brackets, two-part fabric or any combination thereof.

Still referring to FIG. 2A, the system 200 also preferably includes an input means 202, such as a microphone, configured for inputting communication signals into the control unit 201 from sound or voice. The communication signals that are input through the input means 202 can be recorded or transmitted to a compatible receiving device (not shown). As described above, the control unit 201 can also include a player unit, for playing recorded or stored content data and a memory unit for recording and storing content data. To improve the quality of the bone conduction output signals from the one or more bone conduction speakers 209, sound filter ear plugs 215 that block noise or selected frequencies of noise can be employed.

FIG. 2B shows a system 250 that includes a helmet 251 with a pair of bone conduction speakers 255 and 257. The bone conduction speakers 255 and 257 are permanently or detachably coupled to the inside of the helmet 251, such that the bone conduction speakers 255 and 257 are held in contact with a portion of a user's head while the user is wearing the helmet 251. The bone conduction speakers 255 and 257 preferably include diaphragms for generating audible sounds through bony portions of the user's head, as described above.

In accordance with the embodiments of the invention, the system 250 also includes a microphone 253, wherein the bone conduction speakers 255 and 257 and the microphone 253 serve as two-way communication headset 256 suitable for delivering and generating two-way radio communication signals.

Still referring to FIG. 2B, the system 250 also includes a control unit 259 that includes a transceiver 263, an antenna 271 and a battery 267 for receiving radio communication signals and delivering communication signals to the user through the bone conduction speakers 255 and 257 and for transmitting radio communication signals generated by the user's voice through the microphone 253. The control unit 259 can be electrically coupled to the headset 256 through one or more wires 260 and a connector 261. The connector 261 can be configured to allow the headset 256 to be detectably coupled to the control unit 259. In accordance with further embodiments of the invention, the headset 256 and the control unit 259 are configured to couple through a wireless connection. The control unit 259 can be configured to couple to the helmet 251, a portion of a vehicle, such as a motorcycle, or a portion of the user's body through any suitable means. Further, the control unit 259 can include a media player unit 265 for playing recorded or stored media content data, such as described above.

FIG. 2C shows a system 275 that includes a pair of glasses 282 with built-in bone conduction speakers 281 and 283, in accordance with the embodiments of the invention. The bone conduction speakers 282 and 283 are preferably molded or otherwise coupled to the frame of the pair of glasses 281. Wires 284 can also be molded into the frame of the pair of glasses 282 to provide the necessary electrical connections to deliver content data to the user through the bone conduction speakers 281 and 283. Preferably, the bone conduction speakers 281 and 283 are held in contact with bony portions of the user's head while the user is wearing the pair of glasses 282 and the bone conduction speakers 281 and 283 preferably include diaphragms (not shown) for generating audible sounds through the bony portions of the user's head, as described above. The diaphragms are preferably flexible and resilient, such that the diaphragms can conform to contours of the bony portions of the user's head for efficient transmission of bone conduction signals.

Still referring to FIG. 2C, the system 275 also includes a control unit 290 that includes a receiver 293, an antenna 291 and a battery 295 for receiving radio communication signals delivered to the user through the bone conduction speakers 281 and 283. The control unit 290 can be electrically coupled to the bone conduction speakers 281 and 283 through one or more wires 287 and a connector 288. The connector 288 can be configured to allow the bone conduction speakers 281 and 283, along with the pair of glasses 282, to detectably couple to the control unit 290. In accordance with further embodiments of the invention, the bone conduction speakers 281 and 283 and the control unit 290 are configured to couple through a wireless connection. The control unit 290 can be configured to couple to the pair of glasses 282, a portion of a vehicle, such a bicycle, or a portion of the user's body through any suitable means. Further, the control unit 290 can include a media player unit 297 for playing recorded or stored media content data, such as described above.

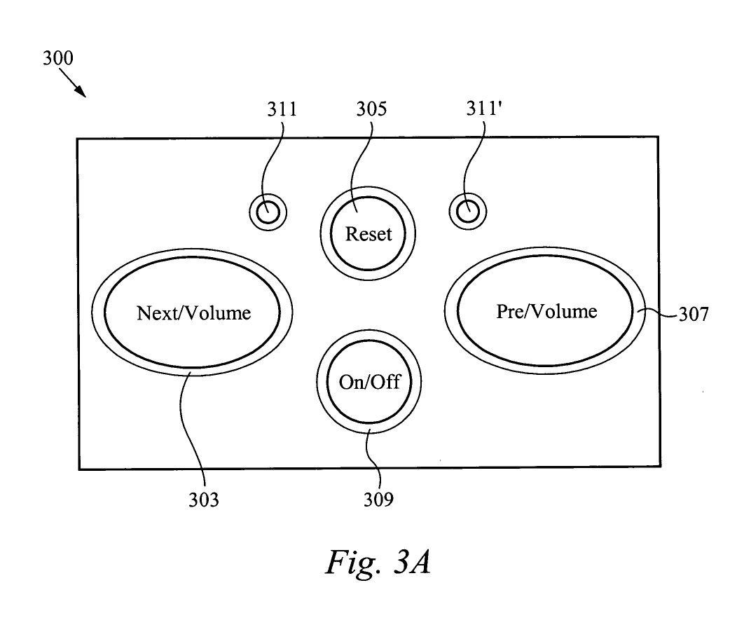

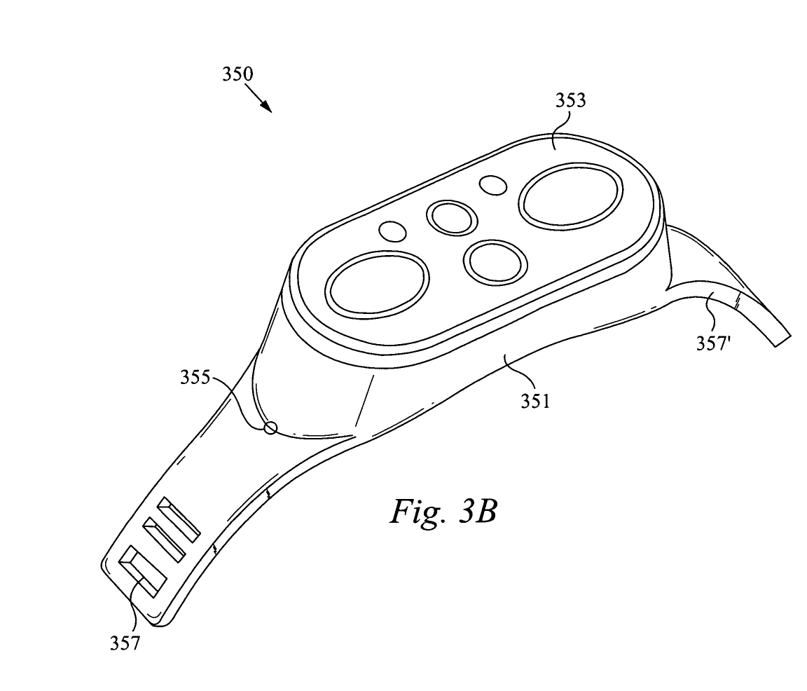

FIG. 3 shows a schematic of control unit 300 with a media player unit, in accordance with the embodiments of the invention. The control unit 300 can comprise a number of controls 303, 305, 307 and 309, which allow a user to input operational commands such as changing an output volume, selecting a media file to be played, turning the media player unit on and off, resetting the media player unit, tuning a radio receiver, to name a few. The touch control buttons 303, 305, 307 and 309 can be used in conjunction with firmware that allows the control unit 300 to be programmed in any number of different ways, such as to play a preferred play list of content data, to turn on or turn off at a selected time, to name a few. The control buttons 303, 305, 307 and 309 and/or the control unit 300 can also include one or more display lights 311 and 311′ that provide an indication of the operational state of the control unit 300. For example, the display lights 311 and 311′ can indicate when the control unit 300 is on, when the control unit 300 is playing prerecorded or stored content data and the like. The display lights 311 and 311′ are preferably LED display lights. The control unit 300 can also include a LCD displays and a number pad for dialing numbers and/or sending text messages from the control unit 300. A bone conduction system in accordance the embodiments of the invention can have any number of different control buttons and/or display features that include LED arrays and/or LCDs and can also include an audible indicator, such as an alarm that signals a time or status of the system.

FIG. 3B shows a control unit 350 configured to couple to a portion of a user's body, in accordance with the embodiments of the invention. The control unit 350 can include a MP3 player, a radio receiver, a transmitter, an antenna, a data storage unit and a battery that is housed within a water resistant housing 351. Preferably, the water resistant housing 351 includes a touch control panel 353 with touch control buttons for inputting control commands to operate the control unit 350, such as described with reference to FIG. 3A. The control unit 350 can also include one or more attachment features 357 and 357′ coupled to the water resistant housing 351. The attachment features 357 and 357′ can be configured to attach to a strap (not shown), which can then be used to secure the control unit 350 to a portion of a user's body.

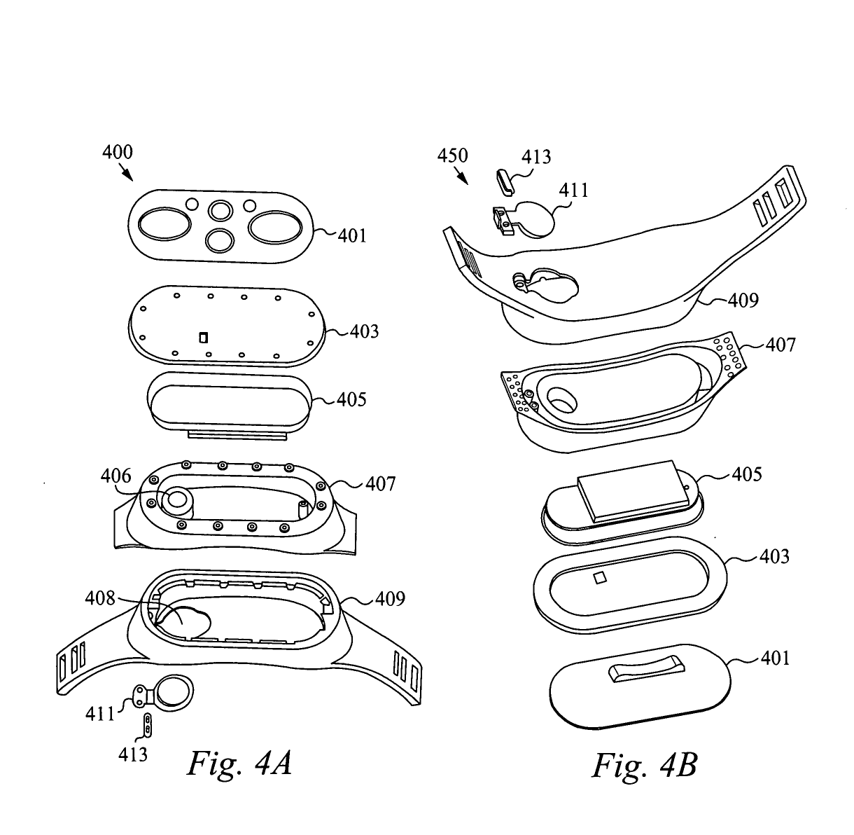

Still referring to FIG. 3B, the water resistant housing 351 and the attachment features 357 and 357′ are preferably formed from molded plastic or rubber. The control unit 350 has at least one output connection 355 for connecting to one or more bone conduction speakers and or a headset with one or more bone conduction speakers, such as described with reference to FIGS. 2B-2C, respectively. Also, the control unit 350 is preferably configured with an input port for connecting to a data source, as described below with reference to FIGS. 4A-B.

FIGS. 4A-B show exploded views 400 and 450 of a control unit, in accordance with the embodiments of the invention. FIG. 4A shows a top exploded view 400 and FIG. 4B shows a bottom exploded view 450, respectively. The control unit can be formed from a top control pad 401 with touch controls for inputting control commands, as described above with reference to FIGS. 3A-B. Next, the control unit can include an upper casing 403 that fits into a lower casing 407 to form a housing structure for housing an electronic unit 405. The electronic unit 405 preferably includes all of the necessary circuitry, memory, amplifiers, power source and processing capabilities required for transmitting radio signals, receiving radio signals, downloading content data, storing content data and playing content data. Next, the control unit has a strap casing 409 that fits to the housing structure formed from the upper casing 403 and the lower casing 407 and preferably provides a means for securing the housing portion to a user's body.

Still referring to FIGS. 4A-B, the lower casing 407 and the strap casing 409 can have apertures 406 and 408, respectively, that form an input port for inputting data files to the electronic unit 405. The input port can be covered with a cap structure 411 that is secured to the strap casing 409 through a rivet member 413. All of the components 401, 403, 405, 407, 409, 411 and 413 that combine to form the control unit can be secured, fitted or interlocked together using any number of securing mechanisms including, but not limited to, rubber rivets, glue and the like. Furthermore, the control unit of the present invention can include any number of gaskets or seals required to provide durability and/or water resistance required for the intended use.

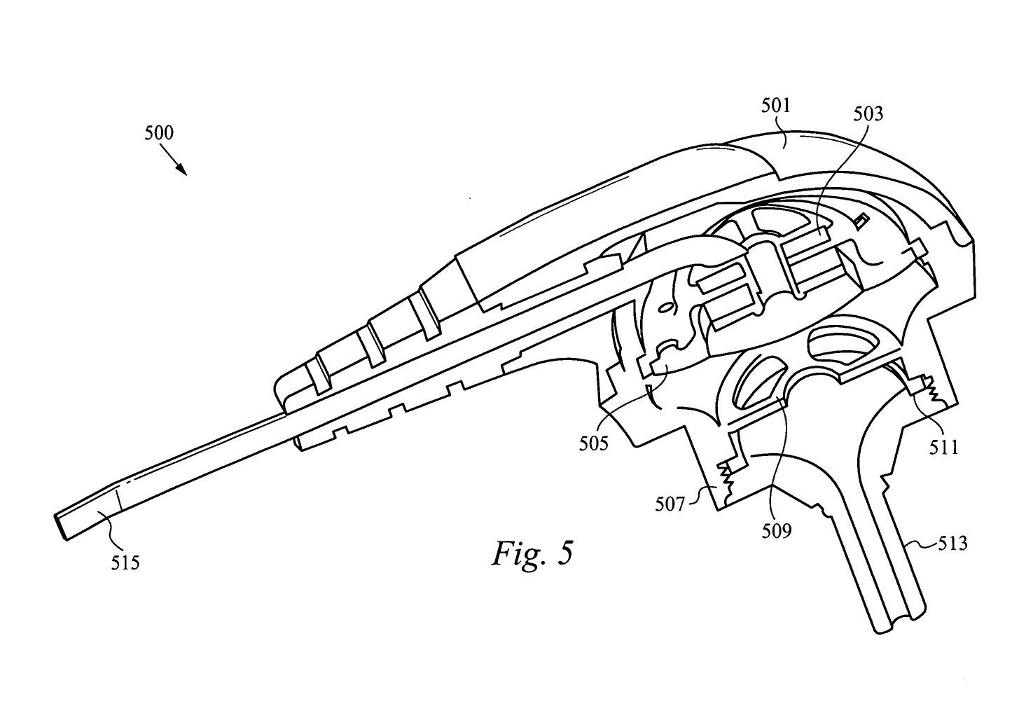

FIG. 5 shows a water resistant ear plug/speaker unit 500 that can be used for outputting a representation of audio signals generated by a player unit, such as described above. The water resistant ear plug/speaker unit 500 comprises a housing 501 for housing electronic components of the ear plug/speaker unit 500. The ear plug/speaker unit 500 preferably comprises a nozzle or cone structure 513 for inserting into a user's's ear and delivering sound to the user's ear therefrom. An outer portion 507 of the nozzle or cone structure 513 can be formed from a soft malleable material that allows the ear plug/speaker unit 500 to adapt to different ear shapes. The cone structure 513 can be sealed to the outer portion 507 through a rubber gasket 511. Within the housing 501, there is a fenestrated member 509 that allows water to drain from a cavity between the fenestrated member 509 and a transducer 503. Preferably, the transducer 503 has a sealed membrane structure 505 that oscillates to generate sound from audio signals received by a media player unit through a water resistant electrical connection 515.

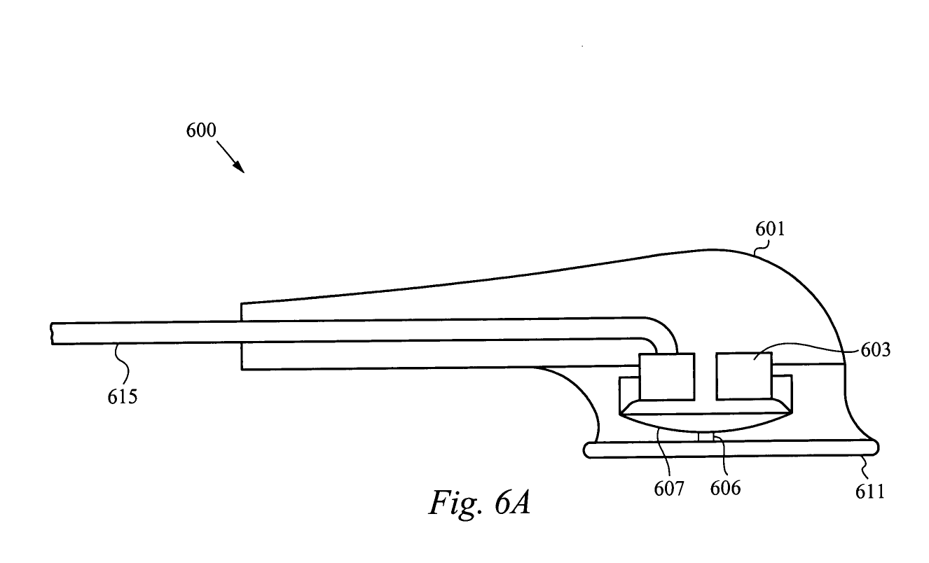

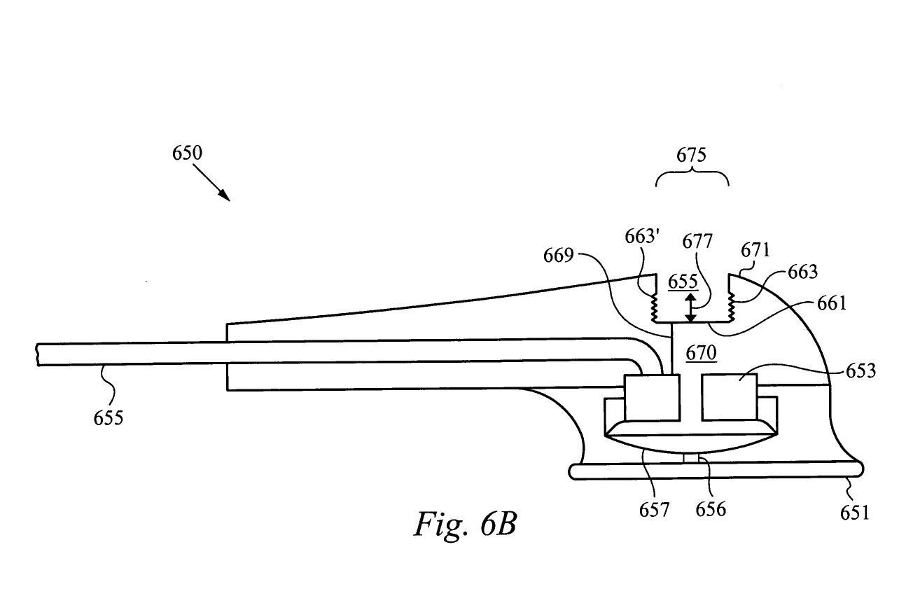

FIG. 6A shows a bone conduction speaker unit 600 for providing bone conduction transmission of content data generated by a control unit, in accordance with a preferred embodiment of the invention. The bone conduction speaker unit 600 comprises a housing 601 for housing electronic components of the bone conduction speaker unit 600. The bone conduction speaker unit 600 preferably comprises a transducer 603 with an oscillating diaphragm 607 that vibrates in response to content data signals processed by the control unit, such as described in detail above with reference to FIGS. 1, 2A-2C, 3A-3B and 4A-B, and transmitted through a water resistant electrical connection 615 or wireless connection. The bone conduction speaker unit 600 is preferably water resistant and includes a sealed membrane 611 that is configured to be placed on and secured against a bony portion of the user's head to transfer vibrations therefrom and which generate signals that are audible from the inner portion of the user's ears. The bone conduction speaker 600 can include a coupling structure 606 that is configured to facilitate mechanical transmission of vibrations from the oscillating diaphragm 607 to the sealed membrane 611. Alternatively, the oscillating diaphragm 607 can be sealed and placed in direct contact with a bony portion of the user's head to transmit sound therefrom. As stated above, the bone conduction speaker 600 can be secured to bony portions of a user's head using any number of means including, but not limited to, brackets, clips and straps that are either part of the system or that are separate from the system. Preferably, the bone conduction speaker 600 can be secured to bony portions of a user's head through headgear, such as a headband, a visor, a hat, a helmet, a pair of goggles, a pair of glasses and combinations thereof.

FIG. 6B shows a bone conduction speaker unit 650 for providing bone conduction transmission of content data generated by a control unit, in accordance with further embodiments of the invention. The bone conduction speaker 650 comprises a housing 671 for housing electronic components of the bone conduction speaker unit 650, such as a transducer 653, an oscillating diaphragm 657 and a coupling structure 656, such as described above with reference to FIG. 6A. The bone conduction speaker unit 650 preferably includes a sealed diaphragm that allows the bone conduction speaker unit 650 to be used under water or in aquatic environments and can conform to contours of the user's head. The bone conduction speaker unit 650 also preferably includes a pressure compensator 675 for reducing the pressure deferential between the outside 655 of the housing 671 and the inside 670 of the housing 671. This allows moving parts, such as the oscillating diaphragm 657, the coupling structure 656 and a sealed diaphragm 651, to operate at greater depths of water. Without the pressure compensator 675, in deep water the pressure differential across the moving parts of the bone conduction speaker unit 650 can become so great that the bone conduction speaker unit 650 fails to function properly. The pressure compensator 675 can also help equalize the pressure differential between the outside 655 of the speaker housing 671 and the inside 670 of the speaker housing 671 at low pressure conditions, such as at high altitudes, and thus help the bone conduction speaker unit 650 maintain consistent performance in a variety of pressure conditions.

The pressure compensator 675 can include a movable pressure diaphragm 661 that can be displaced, as indicated by the arrow 677, through compression regions 663 and 663′ in response to pressures changes. The pressure compensator 675 can also include a controller arm 669 for controlling or regulating the displacement of the pressure diaphragm 661 in response to the pressure changes. Details of pressure compensators are further described in U.S. Pat. No. 5,678,541, titled “BREATHING REGULATOR APPARATUS HAVING AUTOMATIC FLOW CONTROL,” the contents of which are hereby incorporated by reference.

In operation, the sealed membrane 651 of the bone conduction speaker unit 650 is placed on and secured against a bony portion of the user's head. The bone conduction speaker unit 650 generates vibrations from content data signals processed by a control unit, such as described in detail above, and transmitted through a water resistant electrical connection 655 or wireless connection. The vibrations from the sealed diaphragm 651 are transferred to the bony portion of the user's head to generate audible signals at the inner portion of the user's ears. As the bone conduction speaker unit 650 is operated through a range of pressures, the pressure diaphragm 661 moves, as indicated by the arrow 677, to reduce the pressure differential between the outside 655 and the inside 670 of the housing 671.

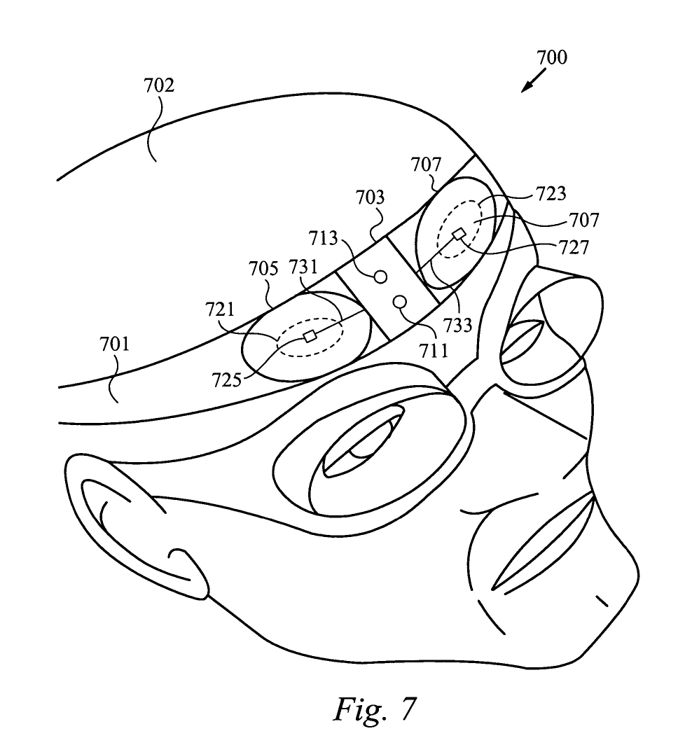

FIG. 7 illustrates a system 700 that is configured to attach to a user's head 702, in accordance with further embodiments of the invention. The system 700 is configured to wrap around a forehead portion of the user's head 702 through a flexible strap 701. The system 700 comprises a control unit 703 with all of the necessary components to receive, store and play content data files and/or receive and transmit radio communication signals, including a processor, a memory unit, a power source, an amplifier circuit, a radio transmitter, a radio receiver and an antenna, such as described in detail above. Also, the system 700 is preferably configured with controls and/or displays 711 and/or an input port 713, also described above. In accordance with this embodiment, the system 700 comprises water resistant bone conduction speakers 705 and 707 that are built into the strap 701 and housed in water resistant housing structures on the strap 701. The water resistant bone conduction speakers 705 and 707 comprise transducers 725 and 727 with sealed membranes 721 and 723 that are configured to be placed in contact with and contour to the user's forehead and are held against the user's forehead through the strap 701. The transducers 725 and 727 are coupled to the control unit 703 through sealed electrical connections 731 and 733 to receive processed content data generated from the control unit 703, which converts the content data to bone conduction signals that are then transmitted to the user through the user's forehead to generate audible signals within one or more cavities of the user's head 702.

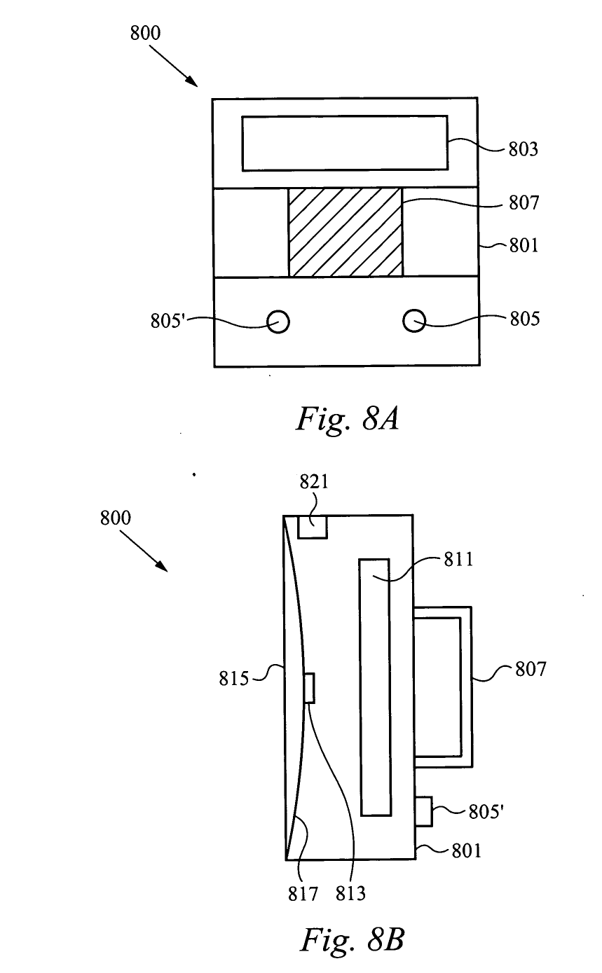

In accordance with yet further embodiments of the invention, a system 800, such as described with reference to FIGS. 1 and 2A-2C, 3A-3B and 4A-4B, and shown in FIGS. 8A-8B, includes a control unit 811 with a timing circuit. The timing circuit is preferably programmable to allow a user to select a frequency of timing signals or a beat (a range of frequencies and/or sequence of timing signals with a range of frequencies) through one or more input buttons 805 and 805′. The control unit 811 can include all of the necessary components to receive, store and play content data files and/or receive and transmit radio communication signals. The control unit 811, in addition to the timing circuit, can include, for example, a processor, a memory unit, a power source, an amplifier circuit, a radio transmitter, a radio receiver and an antenna, such as described in detail above. The system 800 can be used as a coaching device to provide audible cues at the selected frequency or beat to be followed during an exercise routine or other repetitive motion activity. The audible cues help the user to regulate the pace of the exercise routine or repetitive motion activity. For example, the system 800 can be used by swimmers, wherein the system 800 is configured to detachably coupled to swim goggles through an attachment feature or clip 807.

Referring to FIG. 8A, the system 800 includes a waterproof housing 801 for housing the control unit 811 and all of the necessary circuitry, such as described above. The system 800 can also include an input port 821 for downloading content data, programs or other data from a computer or other compatible device. Where the control unit 811 includes a radio receiver, the system 800 can be programmed or operated remotely using a master controller and/or communication signals can be sent to the system 800 through the master controller or any other device with a compatible radio transmitter. The system 800 can also include a display 803 for showing a graphic representation of the operational state of the system, such as the currently selected program, frequency or beat rate, the time of day, names of content data or files stored, programs that are available on the system 800 or any other information which may be useful to the user.

In use, a sealed diaphragm 815 of a built-in bone conduction speaker is held against and conforms to a portion of a user's head. The sealed diaphragm 815 can be held against the portion of the user's head with any suitable headgear, such as described above. The timing circuit generates timing signals at a selected frequency or beat. The timing signals are converted to vibrations through a transducer 813 with an oscillating diaphragm 817. The vibrations from the oscillating diaphragm 817 are transferred to the sealed diaphragm 815 through any suitable mechanism and to the portion of the user's head. The vibrations move through bone in the user's head and generate audible representations of the timing signals within one or more cavities of the user' head, such as the user's inner ears. Other features of systems that include timing circuits are described in U.S. patent application Ser. No. 10/632,464, filed Aug. 1, 2003, and titled “ELECTRONIC PACE REGULATING, TIMING, AND COACHING DEVICE AND SYSTEM,” the contents of which are hereby incorporated by reference.

There are a number of devices available for delivering content data to a user electronically in an audible form. However, many of these devices are not well suited for use while performing other activities where the user would like to or needs to hear other sounds in the environment. Further, many of the currently available devices are not well suited to operate in aquatic environments and/or are not configured to deliver music to a user and to operate as a two-way communication system.

The present invention has been described in terms of specific embodiments incorporating details to facilitate the understanding of the principles of construction and operation of the invention. As such, references, herein to specific embodiments and details thereof are not intended to limit the scope of the claims appended hereto. It will be apparent to those skilled in the art that modifications can be made in the embodiment chosen for illustration without departing from the scope of the invention.

What is claimed is:

1. A system comprising:
a) headgear;
b) a receiver configured to receive wireless content data;
c) a converter coupled to the headgear for converting received wireless content data into bone conduction output data; and
d) a transmitter coupled to the headgear and for transmitting wireless communication signals generated by sound.

2. The system of claim 1, wherein the receiver is a radio receiver.

3. The system of claim 1, wherein the transmitter is a radio transmitter.

4. The system of claim 1, wherein the headgear is headgear selected from the group consisting of a headband, a visor, a hat, a helmet, a pair of goggles and a pair of glasses.

5. The system of claim 1, further comprising a player unit for playing recorded content data through the converter.

6. The system of claim 5, wherein the player unit is configured for playing digital content data.

7. The system of claim 6, further comprising means to record the content data.

8. The system of claim 1, wherein the converter includes one or more transducers configured to contact a user's head while wearing the head gear.

9. A system comprising:
a) a timer unit for generating timing signals at a selectable frequency; and
b) one or more bone conduction speakers coupled to the timer unit, wherein the one or more bone conduction speakers convert the timing signals to timing outputs.

10. The system of claim 9, further comprising a receiver unit coupled to the one or more bone conduction speakers for receiving wireless content data, wherein the one or more bone conduction speakers convert the wireless content data into content output.

11. The system of claim 9, wherein the one or more bone conduction speakers comprise sealed diaphragms for contacting a bony portion of a user's head.

12. The system of claim 9, further comprising a media player for playing digital content data.

13. The system of claim 12, further comprising means for recording the digital content data.

14. The system of claim 9, further comprising means to couple the timer unit or the one or more bone conduction speakers to headgear.

15. A system for two-way communication, the system comprising:
a) a transceiver for receiving incoming wireless communication signals and transmitting outgoing wireless communication signals;
b) a speaker for converting the incoming wireless communication signals into bone conduction signals; and
c) a microphone for converting sound into the outgoing wireless communication signals.

16. The system of claim 15, further comprising means for coupling the speaker and the microphone to a user's head.

17. The system of claim 16, wherein the means for coupling the speaker and the microphone to a user's head includes a head band, a visor, a hat, a helmet, a pair of goggles or a pair of glasses.

18. The system of claim 15, further comprising a digital player for playing and recoding digital music.

19. The system of claim 15, wherein the transceiver is a radio transceiver.

20. The system of claim 19, wherein the radio transceiver is configured to receive and transmit radio packet content data.
